(19) United States
(12) Patent Application Publication
(10) Pub. No.: US 2026/0179488 A1
(43) Pub. Date: Jun. 25, 2026

(54) AUTOMATED DRIVING PLAN NOTIFICATIONS

(71) Applicant: QUALCOMM Incorporated, San Diego, CA (US)

(72) Inventor: Onn HARAN, Even Yehuda (IL)

(21) Appl. No.: 19/425,900

(22) Filed: Dec. 18, 2025

Related U.S. Application Data
(60) Provisional application No. 63/738,530, filed on Dec. 24, 2024.

(51) Int. Cl. G08G 1/0967; B60W 50/14; B60W 60/00

(52) U.S. Cl. CPC G08G 1/096791; B60W 50/14; B60W 60/001; G08G 1/096725; B60W 2050/146; B60W 2554/402; B60W 2554/4041; B60W 2554/406; B60W 2556/65; B60W 2720/10; B60W 2720/106; B60W 2720/24

(57) ABSTRACT

This disclosure provides methods, components, devices and systems for automated driving plan notifications. A system at an autonomous vehicle may be configured to obtain first information indicative of one or more road users. The system may be configured to generate a notification message in accordance with the first information. The notification message may include a planned action for the autonomous vehicle. The notification message may also include second information applicable to coordination of the planned action with at least one non-autonomous vehicle road user. The system be configured to transmit, via a transceiver, at least one instance of the notification message to the at least one non-autonomous vehicle road user of after generating the notification message. The at least one instance of the notification message may include respective second information for each road user of the one or more road users.

### CROSS REFERENCES

The present Application for Patent claims benefit of U.S. Provisional Patent Application No. 63/738,530 by HARAN, entitled “METHOD AND APPARATUS FOR WIRELESS AUTOMATED DRIVING PLANS NOTIFICATIONS” and filed December 24, 2024, which is assigned to the assignee hereof and expressly incorporated by reference herein.

### TECHNICAL FIELD

This disclosure relates generally to wireless communication, and more specifically to systems, devices, methods, and techniques associated with automated driving plan notifications. In some examples, the disclosure may relate to sending driving plans of an automated vehicle (AV) to one or more road users outside the vehicle.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN) or some other wireless network) that supports communication between wireless communication devices (e.g., vehicle-to-everything (V2X) devices, network entities, base stations, client devices, one or more user equipments (UEs), and others). Such devices may communicate with one another using a variety of protocols (e.g., direct communication protocols, which may be in accordance with various Institute of Electrical and Electronics Engineers (IEEE) communication standards (IEEE802.11p or IEEE802.11db), or radio access technologies (RATs)), including those of cellular-based systems such as fourth generation (4G) systems (e.g., Long Term Evolution (LTE) systems, such as LTE-V2X), fifth generation (5G) systems (e.g., 5G New Radio (5G-NR) systems, such as NR-V2X), and sixth generation (6G) systems. A wireless communication network may support communication by implementing system resources (such as frequency resources, time resources, spatial resources) in accordance with a wireless communication protocol.

One of the primary challenges for Automated Vehicles (AVs) is effectively sharing the road with other users, including drivers, cyclists, and pedestrians. The inability to make eye contact with the AV driver complicates basic interactions, such as confirming that a road user has been seen and given the right of way.

FIG. 1A shows an example of an AV decision system 100. The system 100 may include one or more sensors 102, a V2X unit 104, a sense unit 106, a plan unit 108, one or more antennas 112, and a display unit 110, among other examples. In some cases, the sensors 102 may include a variety of sensors (e.g., vehicular sensors) and sensor types. For instance, the sensors 102 may include one or more cameras, one or more radar sensors, one or more lidar sensors, or any combination thereof. The sensors 102 may relay (e.g., transmit, convey, indicate) their outputs to the sense unit 106.

The V2X unit 104 may be coupled with the antennas 112. For example, the V2X unit 104 may be configured to receive data from one or more other road users (e.g., UE devices, V2X devices, non-AVs, among other example road users).

The sense unit 106 may be configured to identify road users that are nearby the AV. In some cases, the sense unit 106 may (optionally) integrate data about various road users from the V2X unit 104. For example, the sense unit 106 may identify one or more road users and/or generate output data based on data from the sensors 102, data from the V2X unit 104, or both. The sense unit 106 may output the information related to the identification of road users to the plan unit 108. In some cases, the plan unit 108 may determine one or more vehicle actions, such as speed adjustments and steering adjustments. Additionally, relevant information may be displayed via unit 110.

However, some road users outside the vehicle may remain unaware of the AV’s planning processes. In some cases, techniques that include specific lighting to convey vehicle intentions may be implemented, but understanding a new light system may be challenging for road users. Additionally, or alternatively, some techniques may employ cooperative maneuvering using V2X communication. However, such communication may not be interpretable by some devices, such as non-AVs, human drivers, cyclists, pedestrians, or other road users who primarily understand basic right-of-way decisions rather than optimized maneuvers. For instance, these road users may not be able to interpret complex trajectory data with millisecond-precise positioning information used in some AV-to-AV cooperative maneuvering examples.

### SUMMARY

The systems, methods, and devices of this disclosure each have several innovative aspects, no single one of which is solely responsible for the desirable attributes disclosed herein. The following is a summary of some non-limiting aspects of the disclosure:

A method by an apparatus is described. The method may include obtaining, by a system at an autonomous vehicle, first information indicative of one or more road users, and transmitting, via a transceiver, at least one instance of a notification message to at least one non-autonomous vehicle road user of the one or more road users, where the at least one instance of the notification message includes second information applicable to coordinating a planned action for the autonomous vehicle with the at least one non-autonomous vehicle road user of the one or more road users.

An apparatus is described. The apparatus may include transceiver and a processing system, where the processing system includes processor circuitry and memory circuitry that stores code. The processing system may be configured to obtain, by a system at an autonomous vehicle, first information indicative of one or more road users, and transmit, via the transceiver, at least one instance of a notification message to at least one non-autonomous vehicle road user of the one or more road users, wherein the at least one instance of the notification message comprises second information applicable to coordinating a planned action for the autonomous vehicle with the at least one non-autonomous vehicle road user of the one or more road users.

Another apparatus is described. The apparatus may include means for obtaining, by a system at an autonomous vehicle, first information indicative of one or more road users, and means for transmitting, via a transceiver, at least one instance of a notification message to at least one non-autonomous vehicle road user of the one or more road users, where the at least one instance of the notification message includes second information applicable to coordinating a planned action for the autonomous vehicle with the at least one non-autonomous vehicle road user of the one or more road users.

A non-transitory computer-readable medium storing code is described. The code may include instructions executable by one or more processors to obtain, by a system at an autonomous vehicle, first information indicative of one or more road users, and transmit, via the transceiver, at least one instance of a notification message to at least one non-autonomous vehicle road user of the one or more road users, wherein the at least one instance of the notification message comprises second information applicable to coordinating a planned action for the autonomous vehicle with the at least one non-autonomous vehicle road user of the one or more road users.

In some examples of the method, apparatus, and non-transitory computer-readable medium described herein, the second information includes one or more longitudinal parameters, an estimated time of the planned action, a quantity of road users of the one or more road users yielded to by the autonomous vehicle, a respective location for each road user of the one or more road users, a respective type of road user of each road user of the one or more road users, a respective identifier for each road user of the one or more road users, or any combination thereof.

In some examples of the method, apparatus, and non-transitory computer-readable medium described herein, obtaining the first information may include operations, features, means, or instructions for obtaining the first information via data from one or more sensors of the system, where the planned action, the second information, or both may be based on the data from the one or more sensors.

A method by an apparatus is described. The method may include receiving, by a system associated with a non-autonomous vehicle road user via a transceiver, at least one instance of a notification message from an autonomous vehicle, where the notification message from the autonomous vehicle includes a planned action for the autonomous vehicle and information applicable to coordinating the planned action with one or more road users including at least the non-autonomous vehicle road user.

An apparatus is described. The apparatus may include a processing system that includes processor circuitry and memory circuitry that stores code. The processing system may be configured to receive, by a system associated with a non-autonomous vehicle road user via a transceiver, at least one instance of a notification message from an autonomous vehicle, where, to the notification message from the autonomous vehicle, the processing system is further configured to a plan action for the autonomous vehicle and information applicable to coordinate the planned action with one or more road users including at least the non-autonomous vehicle road user.

Another apparatus is described. The apparatus may include means for receiving, by a system associated with a non-autonomous vehicle road user via a transceiver, at least one instance of a notification message from an autonomous vehicle, where the means for the notification message from the autonomous vehicle include means for a planned action for the autonomous vehicle and means for information applicable to coordinating the planned action with one or more road users including at least the non-autonomous vehicle road user.

A non-transitory computer-readable medium storing code is described. The code may include instructions executable by one or more processors to receive, by a system associated with a non-autonomous vehicle road user via a transceiver, at least one instance of a notification message from an autonomous vehicle, where the instructions to the notification message from the autonomous vehicle are executable to a plan action for the autonomous vehicle and information applicable to coordinate the planned action with one or more road users including at least the non-autonomous vehicle road user.

In some examples of the method, apparatus, and non-transitory computer-readable medium described herein, the information of the notification message includes one or more first parameters applicable to the non-autonomous vehicle road user and one or more second parameters applicable to one or more second non-autonomous vehicle road users of the one or more road users.

In some examples of the method, apparatus, and non-transitory computer-readable medium described herein, the information includes one or more longitudinal parameters of the autonomous vehicle, an estimated time of the planned action of the autonomous vehicle, a quantity of road users yielded to by the autonomous vehicle, a respective location for each road user of one or more road users including the non-autonomous vehicle road user, a respective type of each road user the one or more road users, a respective identifier for each road user of the one or more road users, or any combination thereof.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows an example of an automated vehicle decision system.

FIG. 1B shows an example of an enhanced automated vehicle decision system with planning notification that supports automated driving plan notifications.

FIG. 1C shows an example of non- automated vehicle decision system that supports automated driving plan notifications.

FIG. 2A shows an example of a flow diagram that supports automated driving plan notifications.

FIG. 2B shows an example of a flow diagram that supports automated driving plan notifications.

FIG. 3 shows an example of a notification message that supports automated driving plan notifications.

FIGS. 4A through 4E show examples road environments that support automated driving plan notifications.

FIGS. 5 and 6 show flowcharts illustrating methods that support automated driving plan notifications.

FIG. 7 shows a block diagram of an example wireless communication device that supports automated driving plan notifications.

Like reference numbers and designations in the various drawings indicate like elements.

### DETAILED DESCRIPTION

Aspects of the subject matter described in this disclosure may relate to a method and apparatus for wireless automated driving plan notifications.

In some wireless communication systems, automated vehicles (AVs) face challenges in effectively sharing roadways with mixed traffic environments containing both automated and non-automated road users. While some cooperative maneuvering techniques enable automated vehicles to exchange some trajectory data, such

sophisticated communication protocols may not be accessible to or practical for some road users. Such communication barriers may lead to unsafe interactions, as road users outside AVs remain unaware of planned actions by an AV, which may result in conflicts when other road users do not anticipate or respond appropriately to automated vehicle behaviors that differ from typical human driving patterns.

Various aspects relate generally to wireless automated driving plan notifications that enable automated vehicles to communicate planning intentions to mixed traffic environments. Some aspects more specifically relate to generating structured notification messages that include planned vehicle actions and coordination information for multiple road users simultaneously. In some examples, the content of the notification messages may be transmitted in formats that are interpretable by non-automated road users (e.g., non-AV road users). In some examples, automated vehicle systems (e.g., including a user equipment (UE) or some other wireless communication device) may analyze sensor data and vehicle-to-everything (V2X) inputs to identify affected road users, determine multi-road-user relationship mappings indicating whether the AV will yield to or proceed ahead of each road user, and output planning notifications containing comprehensive coordination data through various communication mechanisms that may be suitable for both V2X-equipped and non-equipped road users.

Particular aspects of the subject matter described in this disclosure can be implemented to realize one or more of the following potential advantages. In some examples, by generating structured planning notifications with multi-road-user coordination information, the described techniques can be used to enable safer interactions between automated vehicles and mixed traffic environments. Additionally, by providing more broadly interpretable coordination vocabulary (e.g., rather than complex trajectory data), some aspects enable non-automated road users to understand and respond appropriately to AV planning intentions with reduced processing capabilities. Moreover, by incorporating relationship mapping that simultaneously indicates yielding and proceeding decisions for multiple road users, the described approaches may enable sophisticated coordination scenarios that account for complex multi-user interactions while maintaining simplicity in communication format.

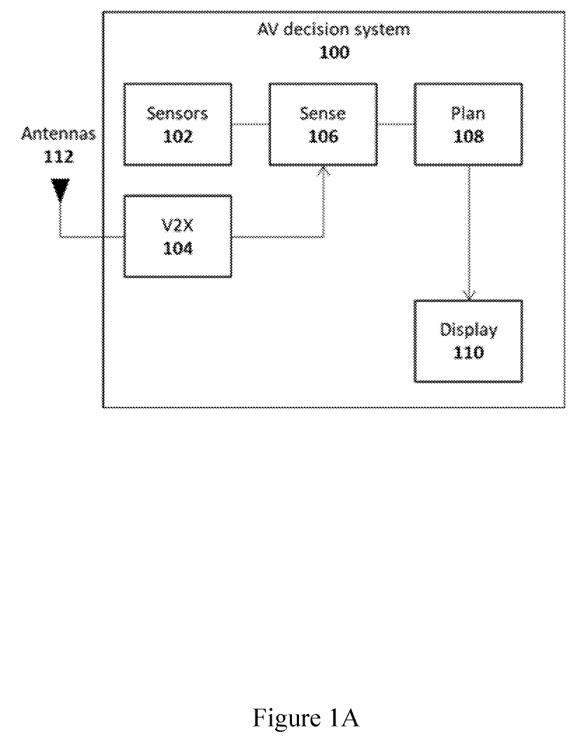

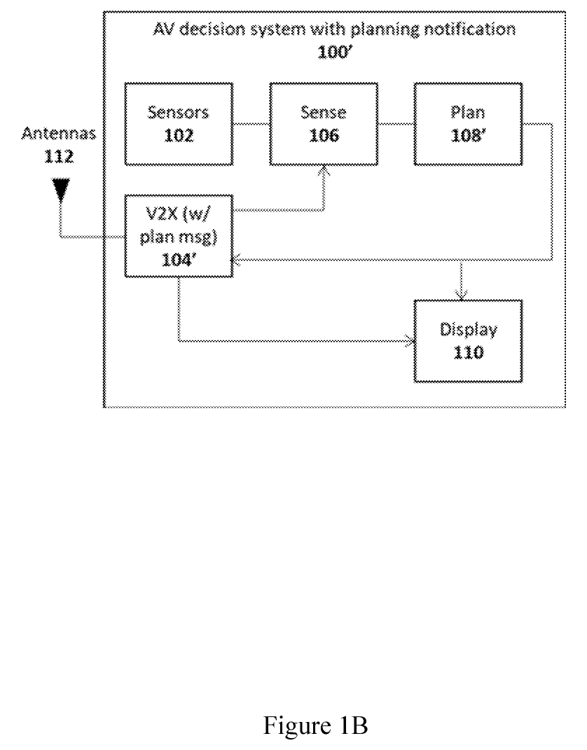

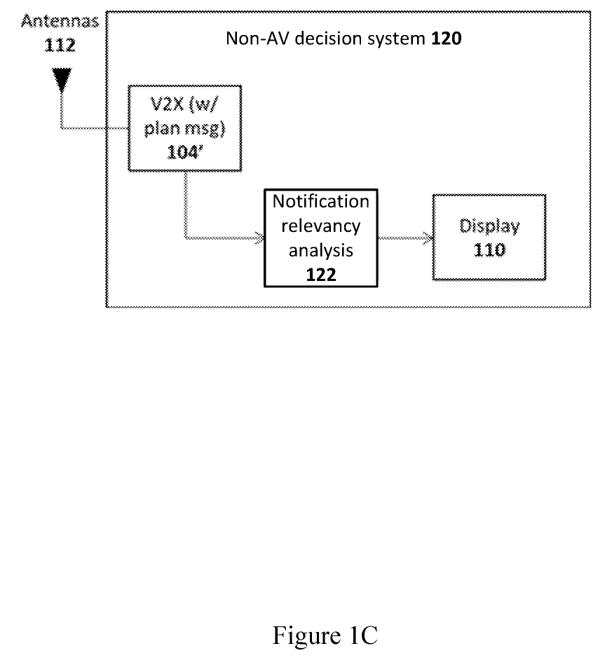

FIG. 1B shows an example of an enhanced automated vehicle decision system 100’ that supports automated driving plan notifications. The system 100’ may be an example of or include various components of the system 100 (e.g., as described with reference to FIG. 1A). For example, the system 100’ may include one or more sensors 102, a sense unit 106, and a display unit 110. The system 100’ may also include a V2X unit 104’ (e.g., which may support various enhancements with respect to the V2X unit 104). For example, the V2X unit 104’ may be configured to output (e.g., generate, transmit, determine, compute) a notification message (e.g., a planning message, a message indicative of one or more actions planned by the AV) via the one or more antennas 112. Additionally, or alternatively, the V2X unit 104’ may be configured to receive data from one or more other road users (e.g., UE devices, V2X devices, non-AVs, among other example road users). Accordingly, the system 100’ may be configured to communicate (e.g., transmit, receive) wireless communication signals (e.g., radio signals, any signal transmitted in accordance with a wireless communication protocol, such as 4G, 5G, or 6G protocols, among other examples). In some examples, the V2X unit 104’ may be configured to transmit data to other road users using V2X communication protocols such as dedicated short range communications (DSRC) or Cellular V2X (C-V2X).

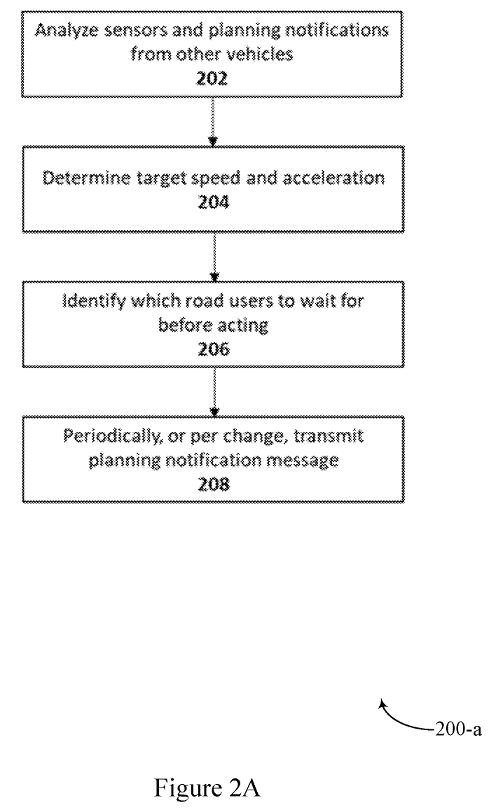

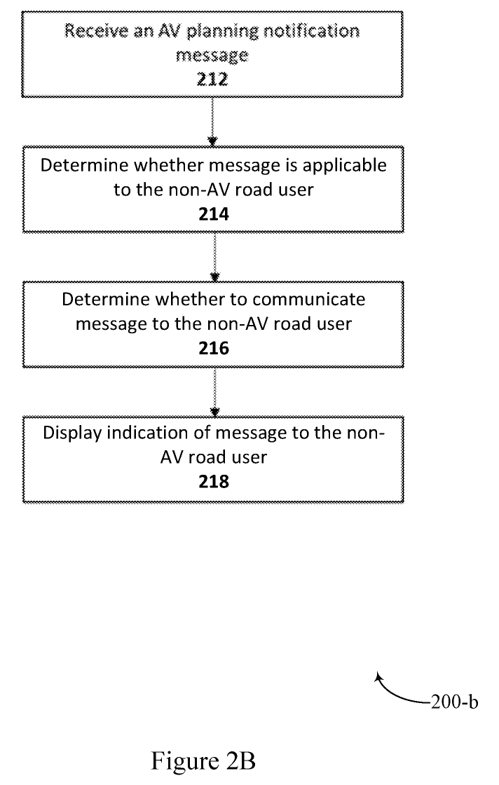

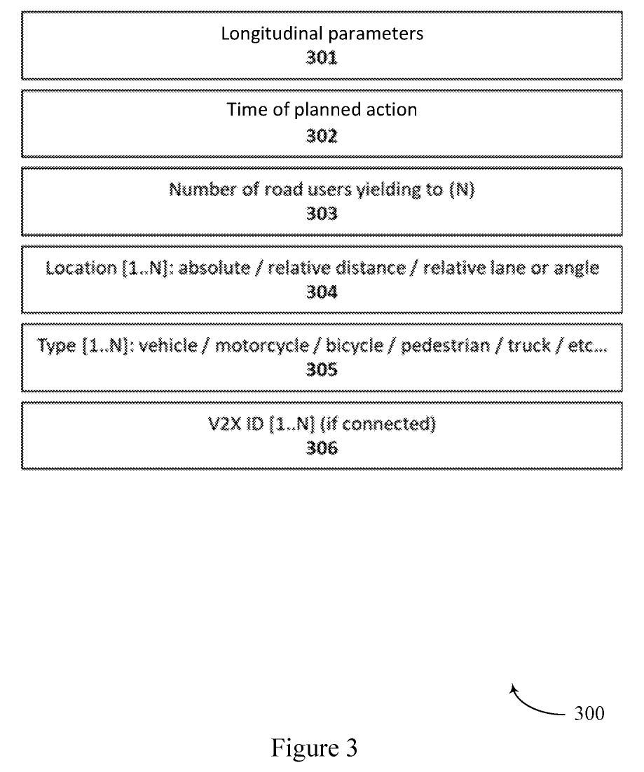

In some examples, the one or more sensors 102 may include one or more cameras, one or more radar sensors, one or more lidar sensors, one or more ultrasonic sensors, one or more inertial measurement units (IMUs), one or more global positioning system (GPS) sensors, one or more magnetometers, other sensors, or any combination thereof. In some examples, the notification message may include structured planning information that communicates intended actions of the AV and coordination details for multiple road users simultaneously, which may enable both automated and non-automated road users to understand the AV’s intentions. Additional details regarding the content, structure, and other aspects of the notification message may be described herein, including with reference to FIGS. 2A, 2B, and 3.

In some examples, the sense unit 106 may analyze sensor data from the sensors 102 to detect objects, classify road user types (e.g., vehicles, pedestrians, cyclists, motorcycles), determine positions and velocities of detected road users, and track movement patterns to make the identification. In some examples, the sense unit 106 may output the information related to the identification of road users (e.g., position information, velocity information, road user type classification, trajectory predictions, relative distances, and threat assessments).

Additionally, or alternatively, the system 100’ may include a plan unit 108’ (e.g., which may support various enhancements with respect to the plan unit 108). For example, the plan unit 108’ may be configured to generate an output that clearly communicates (e.g., in accordance with a standardized format) one or more aspects of the driving plan of an AV to one or more road users (e.g., nearby users). The output may include various aspects of a notification message, such as a planned action for the autonomous vehicle and information applicable to coordinating the planned action with one or more road users (e.g., in accordance with examples described in greater detail herein, including with reference to FIG. 3). In some examples, The plan unit 108’ may integrate data from the sense unit 106 and may also incorporate planning notifications received from other vehicles (e.g., AVs, non-AVs) to generate coordinated planning decisions that account for multiple road users simultaneously. The output of the plan unit 108’ may be sent to the V2X unit 104’ for transmission.

In some examples, the V2X unit 104’ may output at least one instance of the notification message to the one or more road users after generating the notification message. The V2X unit 104’ may transmit the notification message(s) in accordance with a periodicity (e.g., every 1 second), in response to any plan changes, or both to ensure consistent and responsive communication. In some examples, each instance of the notification message may include respective information for each road user involved in the planned action, including relationship data indicating whether the AV will yield to or proceed ahead of each road user. In some examples, at least some content of the notification message may (optionally) be displayed on the display unit 110 to inform vehicle occupants about the planning decisions, affected road users, and coordination status. In some examples, the display unit 110 may show detected road users, planned vehicle actions, system status information, navigation data, and safety alerts to inform vehicle occupants about the AV’s decision-making process.

In some examples, a road user may also include a system that is configured to receive the notification message (e.g., a UE, or some other wireless communication device, which may be at or nearby a road user). Such road user systems may include V2X-equipped vehicles, smartphones carried by pedestrians, cyclists, drivers, and other road users, or display systems (e.g., in non-AVs) that are configured to interpret and present the planning information. For example, the road user system may be configured to receive (e.g., based on a V2X unit, or some other component configured for wireless communication signaling) one or more instances of the notification message from an AV, and the notification message may include a planned action for the AV and information applicable to coordinating the planned action with the road user. In some examples, the notification message may enable the road user system to understand an AV’s immediate intentions, as well as how those intentions relate to multiple road users in the area, which may provide context for safer decision-making. The road user system may thus determine whether to yield to the autonomous vehicle based on (e.g., in response to, after receiving, after reviewing the content of) the notification message. In some examples, the road user system may also include a display unit to display information related to the notification message (e.g., the planned action of the AV) to the road user. The display unit may present the information in various formats appropriate for different road user types, such as visual displays for vehicle operators, audible notifications for pedestrians, or haptic feedback for cyclists, among other examples.

Accordingly, the enhanced system 100’ may enable enabling AVs to communicate their planning intentions to mixed traffic environments containing both automated and non-automated road users. For example, the system 100’ may support a vocabulary that translates sophisticated AV planning decisions into coordination information, which may be simpler to understand by a variety of road users. Such an approach may enable improved interaction and coordination between AVs, non-AVs, human drivers, cyclists, pedestrians, and other users who operate within a roadway environments based on understanding basic right-of-way decisions rather than optimized trajectory maneuvers and positioning data.

FIG. 1C shows an example of non-AV decision system 120 that supports automated driving plan notifications. The non-AV decision system 120 may include a V2X unit 104’, a notification relevancy analysis unit 122, and a display unit 110, among other example components. The non-AV decision system 120 may also be coupled with one or more antennas 112. In some examples, the non-AV decision system 120 may be located at one or more non-AV road users (e.g., a regular vehicle, a motorcycle, a bicycle, a smartphone of a pedestrian).

In some examples, the upgraded V2X unit 104’ may include support for a planning message received from an AV (e.g., received from a system 100’). For example, the V2X unit 104’ may be configured to receive (e.g., obtain, decode) a notification message (e.g., a planning message, a message indicative of one or more actions planned by the AV) via the one or more antennas 112. Additionally, or alternatively, the V2X unit 104’ may be configured to transmit (e.g., output) data to one or more other road users (e.g., UE devices, V2X devices, non-AVs, among other example road users). Accordingly, the system 120 may be configured to communicate wireless communication signals (e.g., radio signals, any signal transmitted in accordance with a wireless communication protocol, such as 4G, 5G, 6G, DSRC, C-V2X, among other examples).

In some examples, a received notification message may be processed in the notification relevancy analysis unit 122. The notification relevancy analysis unit 122 may be configured to determine whether the notification message is relevant to (e.g., pertains to) the non-AV road user (e.g., associated with the system 120) or its anticipated trajectory. The notification relevancy analysis unit 122 may, additionally, or alternatively, be configured to determine whether the notification message is communicated to the road user (e.g., to determine whether the message necessitates driver attention). In some examples, the notification relevancy analysis unit 122 may be configured to output information to the display unit 110. For example, if the road user is to be notified of the notification message, one or more alerts may be output (e.g., displayed, conveyed, played) via the display unit 110. Additional details regarding the operations of the non-AV decision system 120 may be described in greater detail herein, including with reference to FIG. 2B.

Accordingly, the non-AV decision system 120 may enable non-automated road users to participate in the coordinated planning communication network established by automated vehicles. For example, the system 120 may provide an interface between AV planning systems and other road users by receiving, analyzing, and presenting planning notifications in formats appropriate for road user interpretation. Such approaches may allow non-AV road users to make informed decisions based on AV intentions, creating a comprehensive mixed-traffic coordination environment in which both AV and non-AV road users can safely and efficiently share roadway infrastructure through coordinated understanding of planned actions and right-of-way decisions.

FIG. 2A shows an example of a flow diagram 200-a that supports automated driving plan notifications. For example, the flow diagram 200-a may illustrate a flow chart of notification transmission operation at an AV. The flow diagram 200-a may implement or be implemented by aspects of the enhanced automated vehicle decision system 100’, as described with reference to FIG. 1B (e.g., including coordination between the sense unit 106, plan unit 108’, and V2X unit 104’ to generate and transmit structured planning notifications).

In some examples, the operation may begin in accordance with a periodicity (e.g., once every 100 milliseconds). At 202, the sense unit 106 at an AV may analyze data from the sensors(s) 102, inputs from V2X unit 104’, or both. In some examples, the sense unit 106 may also analyze one or more planning notifications received from other AVs (e.g., via the V2X unit 104’) to plan future actions accordingly (e.g., to coordinate with the other AV).

At 204, the plan unit 108’ of the AV may determine various actions to be performed by the AV based on the information received from the sense unit 106, among other example factors. For example, the AV may determine a target velocity (e.g., speed), a target acceleration, a target deceleration, a target direction (e.g., steering angle, lane position), an estimated time of the planned action (e.g., a time of execution of the planned action, when a speed change is expected to start) based on the data from the sense unit 106. In some examples, a target speed may be higher than a current speed, for example, when merging into a faster lane. Alternatively, a target speed may be lower than a current speed when initiating braking. In some examples, an acceleration or deceleration value may be determined based on a determination to adjust to a relatively faster lane without forcing a vehicle behind the AV to slow down, or to avoid hitting an object that triggered the deceleration. Additionally, or alternatively, the plan unit 108’ may determine right-of-way and lane change decisions based on road features and the presence of specific road users, such as planning a lane change (e.g., within the next “X” units of distance such as 100 meters) or yielding at an intersection. The planned actions may include stopping at intersections, continuing through intersections, yielding to specific road users, turning left or right, changing lanes, merging into traffic, or maintaining current trajectory, among other examples.

At 206, the AV may identify one or more road users (e.g., nearby the AV or within a threshold distance of the AV) affected by the action(s) planned by the AV in accordance with the output of the plan unit 108’ (e.g., to determine whether any of the road users may conflict with the planned action). In some examples, the AV determines for each identified road user whether the AV will yield to that road user or proceed ahead of that road user, which may create a comprehensive relationship mapping for all road users involved in the planned action. For example, the AV may determine which road users the AV plans to wait for before proceeding with the planned action. For example, the AV may determine a quantity of road users that the AV plans to yield to.

In some examples, the AV may identify a total quantity of road users, a type of each road user (e.g., vehicles, motorcycles, bicycles, pedestrians, or trucks), an identifier of each road user (e.g., a medium access control (MAC) addresses of a system associated with the road user or a layer 1 identifiers of a system associated with the road user (if they are part of a V2X network)), a relative position of each road user with respect to the AV (e.g., yielding to AV or passing before the AV), or any combination thereof. In some examples, the AV may identify a respective planned action for each road user. For example, when multiple road users are involved, the AV may calculates estimated completion times for each road user and may selects a greater time among them to ensure safe coordination with all affected users. In some examples, when a notification message (e.g., an indication of a planned action by the AV) is targeted at (e.g., directed to, planned for transmission to) a vulnerable road user (VRU) (e.g., a motorcyclist, bicyclist, or pedestrian), the yield indication may not encourage the VRU to claim the right-of-way (e.g., may not indicate the VRU to proceed, may indicate that the AV plans to claim the right-of-way), for example, when other vehicles may pose a risk to the VRU. In some examples, a VRU may be addressed if (e.g., only if) no other vehicle in an adjacent or opposite lane may endanger the VRU.

At 208, the AV may output (e.g., transmit, convey, broadcast, display, or otherwise indicate) one or more planning notification messages (e.g., via the V2X unit 104’). The planning notification messages may include structured data fields as described in greater detail herein (e.g., including with reference to FIG. 3). In some examples, the planning notification message(s) may be transmitted in accordance with a periodicity (e.g., every 1 second). Additionally, or alternatively, the planning notification message(s) may be transmitted in response to a modification of the planned action (e.g., whenever the plan changes). For example, the AV may modify one or more planned actions based on data from the sense unit 106, one or more notification messages from one or more road users (e.g., via the V2X unit 104’), or both. The AV may generate a notification message that includes the modified planned action for the autonomous vehicle and/or other information applicable to coordinating the modified planned action with the road users. The AV may then output the updated notification message to each of the road users.

In some examples, major events (e.g., only major events), such as identifying (e.g., adding) a road user that should be yielded to, significant or prolonged acceleration or deceleration, detecting new road users entering the coordination area, changes in road user relationships (from yielding to proceeding ahead or vice versa), modifications to estimated completion times, or changes in planned action types (from continuing to yielding, from lane change to stopping), among other major event examples may be considered a plan change. In some examples, one or more aspects of the notification message (e.g., an indication of the planned action such as yielding decisions, lane change intentions, intersection navigation plans, or coordination status with specific road users) may optionally be output via a display of the AV (e.g., to inform vehicle occupants about the planning decisions).

Thus, the flow diagram 200-a may enable proactive, structured communication of AV planning intentions to mixed traffic environments. For instance, the techniques may support continuous coordination mechanisms that enable non-automated road users to interpret and respond to AV intentions in real-time (e.g., and also to be cross-compatible with other AVs). In some examples, the multi-road-user relationship mapping capability may enables sophisticated coordination scenarios involving multiple simultaneous interactions, while flexible transmission techniques (e.g., periodic and event-driven transmissions) may ensure both consistency and responsiveness. As such, users with road environments may operate in accordance with increased awareness, faster response times, and improved safety, among other benefits.

FIG. 2B shows an example of a flow diagram 200-b that supports automated driving plan notifications. For example, the flow diagram 200-b may illustrate a flow chart of notification transmission operation at a non-AV. The flow diagram 200-b may implement or be implemented by aspects of the non-AV decision system 120, as described with reference to FIG. 1C (e.g., including coordination between the one or more antennas 112, the V2X unit 104’, the notification relevancy analysis unit 122, and the display unit 110).

At 212, a non-AV system may receive (e.g., via the one or more antennas 112) a notification message (e.g., a notification message 300) from the AV. At 214, the non-AV system may determine whether the notification message is applicable to the road user (e.g., the driver, the cyclist, the pedestrian, or some other user) associated with the non-AV system. For example, to determine whether the notification message is applicable to the road user, the notification relevancy analysis unit 122 may be configured to compare the V2X identifier(s) included in the notification message with the non-AV’s own identifier. If the non-AV’s own identifier matches an identifier of the notification message, the non-AV may determine that the notification message is relevant (e.g., and may otherwise ignore the message).

In some examples, the notification relevancy analysis unit 122 may, additionally, or alternatively, determine whether the planned action is relevant to the non-AV. For example, the system may determine whether one or more of the parameters of the notification message indicate that a planned action by an AV will interfere with the future path (e.g., anticipated trajectory) of the non AV. As a non-limiting example, the planned action by the AV may be considered as relevant to the non-AV when the non-AV occupies a same lane as the AV or a lane to which the AV is planning to merge (e.g., as indicated via an active turn indicator).

At 216, the non-AV system may determine whether the received notification message is communicated to the road user. For example, the system may determine whether the message requires driver attention. In some examples, the system may determine that action is recommended (e.g., action required) by the road user, which may apply when the AV maneuver is expected to compel braking by the non-AV road user. Some examples of such a determination may include scenarios where the AV intends to decelerate to a speed lower than the non-AV road user’s current speed, while the AV is in the same lane as the non-AV road user, or in an adjacent lane from which the AV is planning to change. Alternatively, the system may determine that no action is recommended (e.g., action avoidance), which may apply when braking by the non-AV road user can be avoided. Some examples of such a determination may include cases where the AV intends to yield to the non-AV road user or accelerate from a slower speed while being followed by the non-AV road user in the same lane.

At 218, the non-AV system may display (e.g., via the display unit 110) an indication of the notification message to the road user. In some examples, the system may display an icon, play a sound, or output some other indication or representation of the notification message. For example, the system may generate a graphical indicator and/or a corresponding auditory signal to convey a recommended (e.g., or required) action. In some examples, the system may output a red warning icon and/or an associated alert sound when the AV is about to decelerate (e.g., brake) or perform a maneuver for which action by the non-AV road user is recommended for collision avoidance (e.g., scenarios in which the AV’s planned action necessitates braking by the non-AV road user). In some other examples, the system may output an orange warning icon and/or an associated alert sound when a temporary warning condition exists but is anticipated to resolve, such as when the AV enters a lane at a reduced speed but is expected to accelerate. In some other examples, the system may output a green permissive icon and/or an associated alert sound when the AV intends to yield to the non-AV road user (e.g., provided that no non-yielding traffic is expected). For example, the system may output the green icon and/or sound when a single lane exists per road direction to prevent overpassing by non-yielding vehicles and the yielding AV is the closest to the yielded road user.

Accordingly, the flow diagram 200-b may enable non-AV road users to actively participate in the coordinated planning communication network established by automated vehicles. For example, the systematic approach of receiving, analyzing for relevance, determining action requirements, and providing appropriate visual and auditory feedback may create an intelligent interface that translates AV planning decisions into actionable information for road users. Such approaches may allow drivers, cyclists, and pedestrians to make informed responses based on clear, context-appropriate notifications while ensuring that road users receive timely and appropriate guidance without information overload. For example, the relevancy analysis and warning system (e.g., red for required action, orange for temporary conditions, green for yielding scenarios) may enhance overall traffic safety and coordination in mixed AV and non-AV environments.

FIG. 3 shows an example of a notification message 300 that supports automated driving plan notifications. The notification message 300 may implement or be implemented by aspects of the system 100’, the non-AV decision system 120, the flow diagram 200-a, and/or the flow diagram 200-b. For example, an AV may generate one or more messages in accordance with a format that is based on one or more aspects of the notification message 300 and may output the messages to one or more road users. In some examples, one or more aspects of the notification message 300 may be incorporated in a standardized notification message (e.g., a V2X message). The notification message 300 may, for example, include various fields, and each field may be used to indicate various types of information related to the AV, one or more road users, or both. The example fields described herein are non-limiting, and the notification message may include additional information, fields, or other indications relevant to planned actions by an AV.

In some examples, the notification message 300 may include a field 301, which may indicate (e.g., specify, provide) one or more plan parameters (e.g., vehicle longitudinal parameters). For example, the plan parameters may include a target speed, a target acceleration, a target deceleration, a time at which the action occurs (e.g., when a speed change will begin), a target direction (e.g., steering angle, lane position), braking intensity, merging maneuvers, intersection navigation decisions, or other parameters that describe aspects of the planned action.

In some examples, the notification message 300 may include a field 302, which may indicate (e.g., specify, identify) the estimated time of a planned action. For example, the field 302 may indicate when a speed change will start. In some examples, the start time may be immediate, for example, braking immediately for a pedestrian. Alternatively, the start time may be delayed, such as waiting to complete a lane change before accelerating. Accordingly, in some examples, the field 302 may refer to a start time of a future plan (e.g., the beginning of a lane change) or, in the case of yielding, an estimated time for completing the yield. In some examples, when multiple road users are involved in the planned action, the estimated time may account for the coordination information with all affected users (e.g., selecting the greater time among multiple road users to ensure safe completion of the maneuver).

In some examples, the notification message 300 may include a field 303, which may indicate (e.g., specify, identify) a quantity of road users the AV is yielding to. For example, the field 303 may identify all road users whose actions the AV is waiting for before performing its own action, such as changing lanes or accelerating. In some examples (e.g., on a highway), the field 303 may indicate a single road user. However, the quantity may increase, for example, when the AV plans to perform an action (e.g., change lanes after two vehicles in the adjacent lane have passed). In other examples (e.g., an urban environment), the quantity of the field 303 may be higher (e.g., greater than 1). For example, at a stop sign (e.g., non 4-way stop), the AV may wait for (e.g., yield to) multiple cyclists to pass before the AV proceeds along its planned route. The field 303 may enable road users to understand the complexity of the coordination scenario and anticipate the AV’s timing decisions accordingly. Additionally, or alternatively, based on the field 303, road users may identify other road users whose actions the AV is waiting for before performing its own action, such as changing lanes or accelerating.

In some examples, the notification message 300 may include one or more (e.g., fields 304-306), which may be repeated for each road user involved (e.g., covering details from road user 1 to road user “N”). These per-road-user fields may support individualized relationship mapping, which may enable an AV to communicate its specific intentions regarding each affected road user in a coordination scenario.

In some examples, the notification message 300 may include a field 304, which may indicate (e.g., provide, specify) a location of each road user (e.g., 1to N). In some examples, the location may be indicated in terms of absolute coordinates (e.g., when the road user is stationary, such as a pedestrian waiting to cross a street). Additionally, or alternatively, the location may be indicated in terms that are relative to the AV. For example, the field 304 may specify a distance relative to the AV (e.g., which may be ahead or behind the AV), the lane relative to the AV, an angle relative to the AV (e.g., when lanes are not applicable, for example, referring to another road user which is about to enter a roundabout). Accordingly, the location information may enable road users to identify themselves within the coordination scenario and understand their spatial relationship to the AV’s planned action, facilitating accurate self-identification and appropriate responsive behavior.

In some examples, the notification message 300 may include a field 305, which may indicate (e.g., specify, classify) a type of each road user (e.g., 1 to N), such as a vehicle, motorcycle, bicycle, pedestrian, or truck, among other examples. The road user type classification may enable the AV to communicate coordination information in a manner that is applicable to (e.g., appropriate for) different categories of road users, while also helping each road user identify themselves within the coordination scenario. Based on the field 305, each road user may identify itself by matching its type and/or may identity the type of other road users. In some examples, different road user types may have different capabilities for receiving and interpreting coordination information, and such classification enables adaptive communication strategies.

In some examples, the notification message 300 may include a field 306, which may indicate (e.g., contain, specify) a V2X ID of each road user (e.g., if they are part of the V2X network). For example, the ID may include a MAC address in DSRC or a layer 1 (L1) identifier in C-V2X communication. In some examples, the field 306 may enable enhanced coordination capabilities for network-equipped road users while maintaining compatibility with non-V2X participants, creating a hybrid communication environment that maximizes coordination benefits across mixed traffic scenarios.

In some examples, the notification message 300 may include one or more other fields such as a field to indicate the planned vehicle action, such as stopping, continuing, yielding, turning left, turning right, or changing lanes (left/right). Another example field may include a field to indicate the action point, describing at what point (e.g., in time, at what geographic location) the AV will yield or initiate an action (e.g., a lane change). In some examples, the action point may be represented in absolute coordinates or coordinates relative to the AV’s current position. Another example field may include a field to indicate a quantity of road users involved in the planned action. For instance, the AV may yield to two vehicles, proceed ahead of another road user, or act independently of any road user. Another example field may include a field to indicate a relationship of each road user to the action. For example, the filed may indicate whether the AV is yielding to the road user or proceeding ahead of the road user. For instance, during a yield or lane change, the AV may wait for the road user to pass before proceeding. Alternatively, the AV might decide to move before the road user, such as entering an intersection.

In some examples, one or more fields of the notification message 300 may form a container added to existing V2X messages. For example, a combination of one or more of the fields described herein may be included in a basic safety message (BSM), a cooperative awareness message (CAM), a cooperative maneuvering message, or some other V2X message. Additionally, or alternatively, one or more of the fields described herein may be included as part of a dedicated message (e.g., a new message defined exclusively for the purpose of providing notification information described herein).

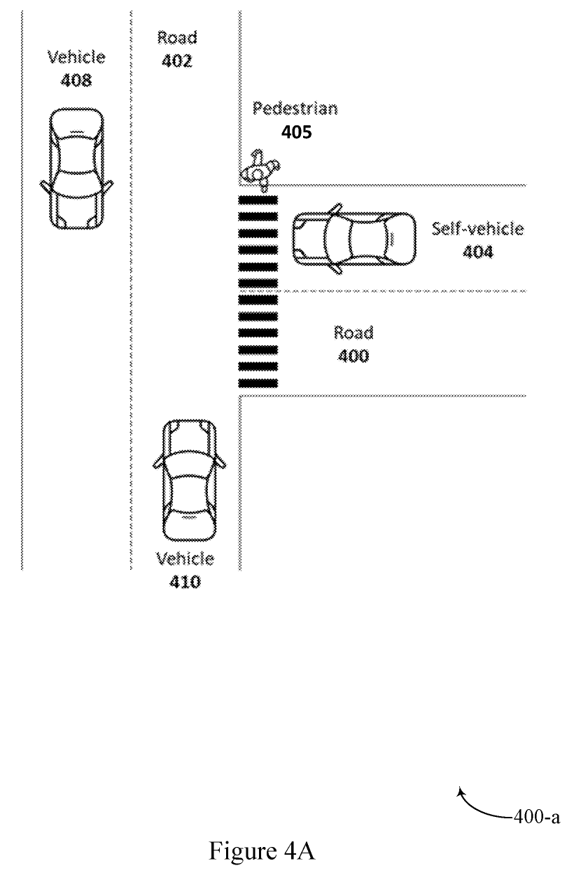

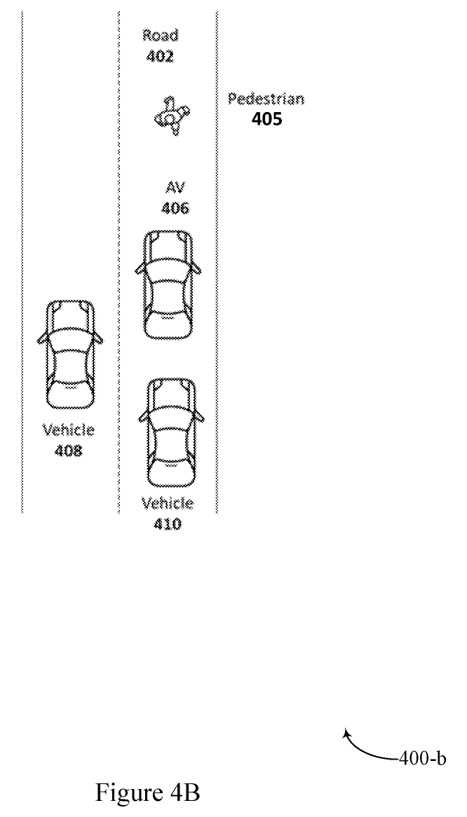

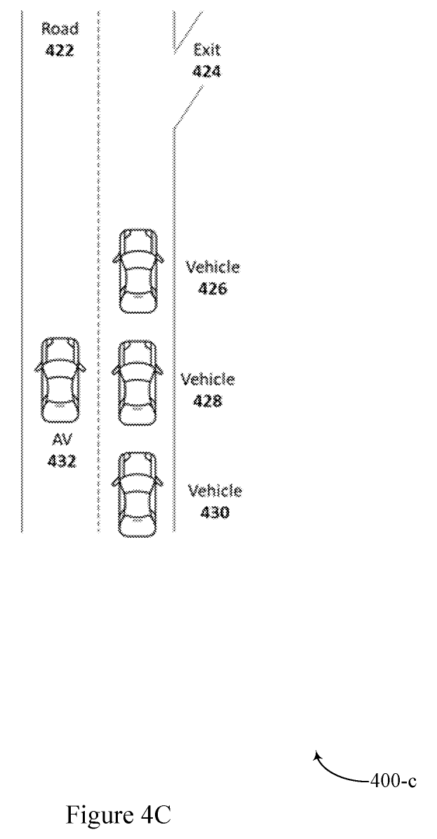

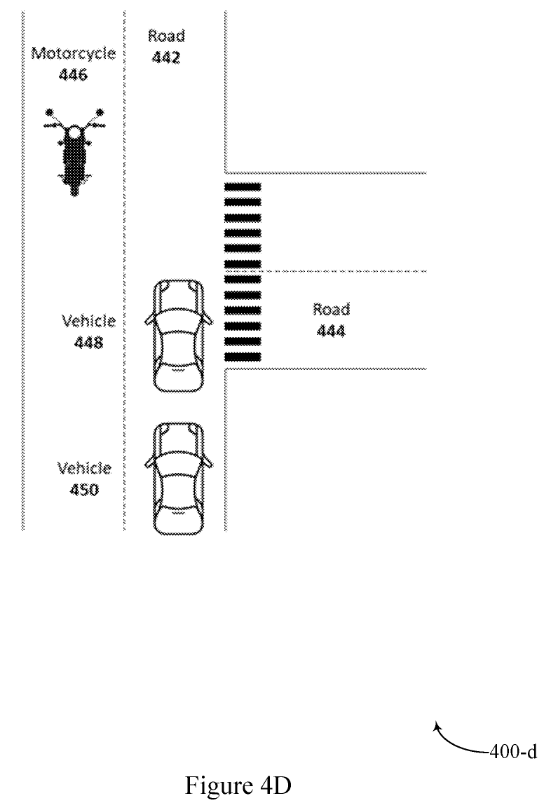

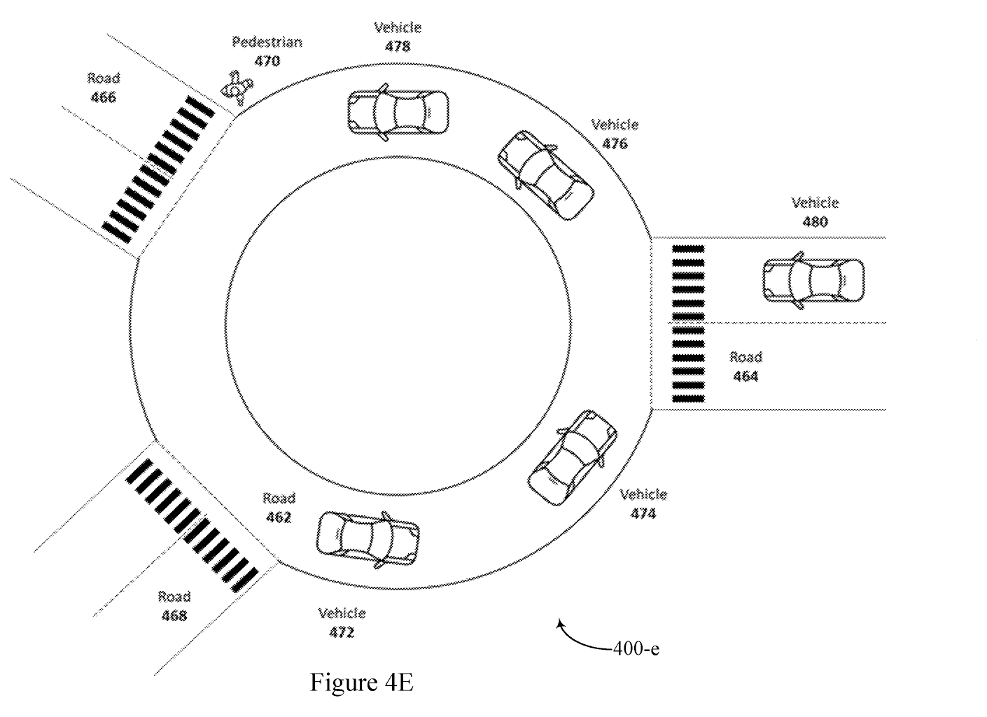

FIG. 4A shows an example of a road environment 400-a that supports automated driving plan notifications. For example, the road environment 400-a may illustrate an example of an AV entering an intersection. Road users within the road environment 400-a may implement one or more aspects of the vehicle decision system 100’, the non-AV decision system 120, the flow diagram 200-a, the flow diagram 200-b, and/or the notification message 300. The self-vehicle 404 (e.g., an AV, which may include a system 100’) may approach the intersection from road 400 and may yield to pedestrian 405 (e.g., regardless of its intended turn direction). If the self-vehicle 404 plans to turn right and vehicle 410 is moving slowly, the self-vehicle 404 may transmit a notification message to announce its intention to yield to pedestrian 405 and then proceed to turn before vehicle 410 reaches the intersection. In some examples, the estimated time for pedestrian 405 to cross the road may be provided in the notification message. Alternatively, if vehicle 410 is moving quickly, the self-vehicle 404 may announce, via a notification message, that it is yielding to both pedestrian 405 and vehicle 410. In this case, a provided time estimation may be the greater of the estimated times for vehicle 410 to cross the intersection and pedestrian 405 to cross the road. In some examples, if the self-vehicle 404 plans to turn left, vehicle 408 will be added to the list of road users to whom it yields.

FIG. 4B shows an example of a road environment 400-b that supports automated driving plan notifications. For example, the road environment 400-b may illustrate an example of an AV 406 encountering a hazard ahead. Road users within the road environment 400-b may implement one or more aspects of the vehicle decision system 100’, the non-AV decision system 120, the flow diagram 200-a, the flow diagram 200-b, and/or the notification message 300. Vehicles 408 and 410 may be non-AVs (e.g., regular vehicles) traveling alongside AV 406 on the same road 402. The AV 406 may suddenly detect a pedestrian 405 on the road. The AV 406 may either attempt braking, if assured of avoiding a collision with the pedestrian 405, while transmitting a notification message to vehicle 410 behind it indicating that hard braking is starting (e.g., to prevent being rear-ended). Alternatively, the AV 406 may change to the left lane, transmitting a notification message indicating a lane change maneuver due to the presence of vehicle 408 in the adjacent lane, to facilitate the lane change. In some examples, the pedestrian 405 may also be notified via a notification message transmitted to a smartphone of the pedestrian 405 (e.g., if their smartphone includes a V2X device) or some other device that is capable of or configured to communicate information to the pedestrian 405.

FIG. 4C shows an example of a road environment 400-c that supports automated driving plan notifications. For example, the road environment 400-c may illustrate an example of an AV attempting a lane change. Road users within the road environment 400-c may implement one or more aspects of the vehicle decision system 100’, the non-AV decision system 120, the flow diagram 200-a, the flow diagram 200-b, and/or the notification message 300. The AV 432 may be driving in the left lane of road 422. The AV 432 may realize late that it needs to perform exit 424. A vehicle 428 may be driving in the right lane, parallel to AV 432, with vehicle 426 ahead of it and vehicle 430 behind it. To reach the exit, AV 432 may have multiple options, such as enter the lane ahead of vehicle 428 or enter behind it. The AV 432 may activate its right-turn signal and select the larger gap. If the gap between vehicles 428 and 430 is larger, the AV 432 may transmit a notification message indicating its intention to brake and yield to vehicle 428. In some examples, vehicle 430 may immediately warn its driver based on the notification message, expecting the AV 432 to change lanes ahead of it. In some examples, if the driver of vehicle 430 does not open a gap, the AV 432 may change its plan and merge behind vehicle 430, decelerating to a lower speed and yielding to vehicle 430. In that case, a warning in vehicle 430 may disappear based on an updated notification message. If the AV 432 decides to change lanes ahead of vehicle 428, the AV 432 may transmit a notification message announcing its planned acceleration, and vehicle 428 may receive a warning if braking is required after the lane change of the AV 432.

FIG. 4D shows an example of a road environment 400-d that supports automated driving plan notifications. For example, the road environment 400-d may illustrate an example of an AV observing a motorcycle turning. Road users within the road environment 400-d may implement one or more aspects of the vehicle decision system 100’, the non-AV decision system 120, the flow diagram 200-a, the flow diagram 200-b, and/or the notification message 300. Motorcycle 446 may be riding on road 442, aiming to turn left onto road 444. On the opposite side, two vehicles, vehicle 448 followed by vehicle 450, may be approaching. If vehicle 448 is an AV and may be about to yield to the motorcycle, after predicting that the motorcycle can complete the turn safely, then the vehicle 448 may transmit a notification message. In some examples, the motorcycle may determine to turn safely based on the notification message, and vehicle 450, being behind vehicle 448, may not pose a risk to the motorcycle. If the vehicle 448 may not be about to yield, then the motorcycle may receive a warning indication via a notification message. In some examples, if vehicle 448 has not yielded and vehicle 450 is an AV planning to yield, the notification message may be transmitted after vehicle 448 has passed the motorcycle to prevent confusion, ensuring the motorcycle does not mistakenly assume that the yield message from vehicle 450 allows it to begin the turn immediately.

FIG. 4E shows an example of a road environment 400-e that supports automated driving plan notifications. For example, the road environment 400-e may illustrate an example of an AV entering a roundabout (e.g., entering road 462 from road 464). Road users within the road environment 400-e may implement one or more aspects of the vehicle decision system 100’, the non-AV decision system 120, the flow diagram 200-a, the flow diagram 200-b, and/or the notification message 300. A vehicle 480 (e.g., an AV) may be approaching the roundabout entry point and may plan to yield to traffic already circulating within the roundabout. A vehicle 474 may be traveling within the roundabout, and vehicle 472 may be traveling within the roundabout behind the vehicle 474. To safely enter the roundabout, the vehicle 480 may transmit a notification message indicating its intention to yield to vehicle 474 currently in the roundabout and then proceed to enter after vehicle 474 passes (e.g., if a gap is sufficient between the vehicle 474 and the vehicle 472). In some examples, the estimated time for vehicle 480 to clear the entry point may be provided in the notification message. In some examples, the vehicle 480 may also signal its intended exit point within the roundabout (e.g., road 466, road 468), allowing other road users (e.g., the pedestrian 470, the vehicle 476, the vehicle 478) to anticipate its path through the circular roadway. The notification message may include relationship data indicating whether the AV will yield to or proceed ahead of each road users based on roundabout right-of-way rules and current traffic conditions.

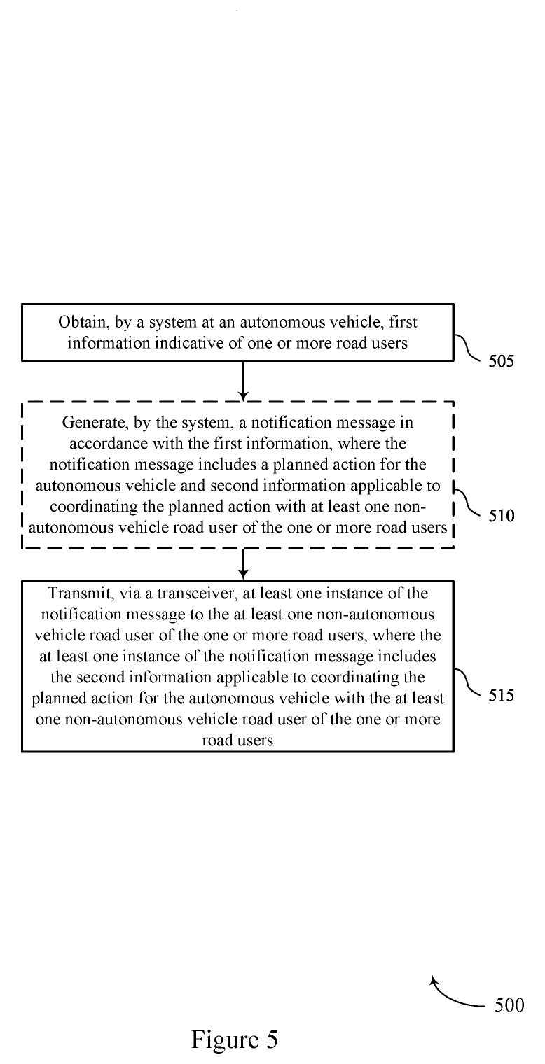

FIG. 5 shows an example of a method 500 that supports automated driving plan notifications. Operations of the method 500 may be performed by a wireless communication devices (e.g., a UE, a system at an AV, a V2X device, or some other device) or its components (such as using a processing system configured to cause the device to perform one or more of the operations) as described herein.

At 505, the method may include obtaining, by a system at an autonomous vehicle, first information indicative of one or more road users.

Optionally, at 510, the method may include generating, by the system, a notification message in accordance with the first information, where the notification message includes a planned action for the autonomous vehicle and second information applicable to coordinating the planned action with at least one non-autonomous vehicle road user of the one or more road users.

At 515, the method may include transmitting, via a transceiver, at least one instance of the notification message to the at least one non-autonomous vehicle road user of the one or more road users, where the at least one instance of the notification message includes the second information applicable to coordinating the planned action for the autonomous vehicle with the at least one non-autonomous vehicle road user of the one or more road users.

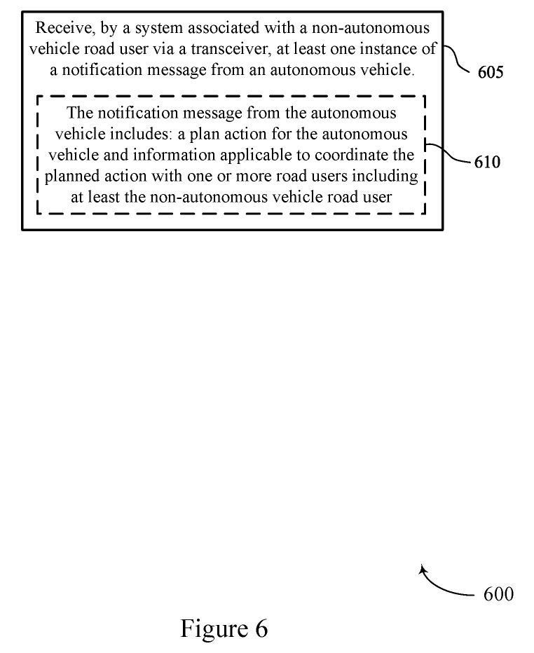

FIG. 6 shows an example of a method 600 that supports automated driving plan notifications. Operations of the method 600 may be performed by a wireless communication devices (e.g., a UE, a system at or otherwise associated with a non-AV road user, a V2X device, or some other device) or its components (such as using a processing system configured to cause the device to perform one or more of the operations) as described herein.

At 605, the method may include receiving, by a system associated with a non-autonomous vehicle road user via a transceiver, at least one instance of a notification message from an autonomous vehicle.

At 610, the notification message from the autonomous vehicle includes a planned action for the autonomous vehicle and information applicable to coordinating the planned action with one or more road users including at least the non-autonomous vehicle road user.

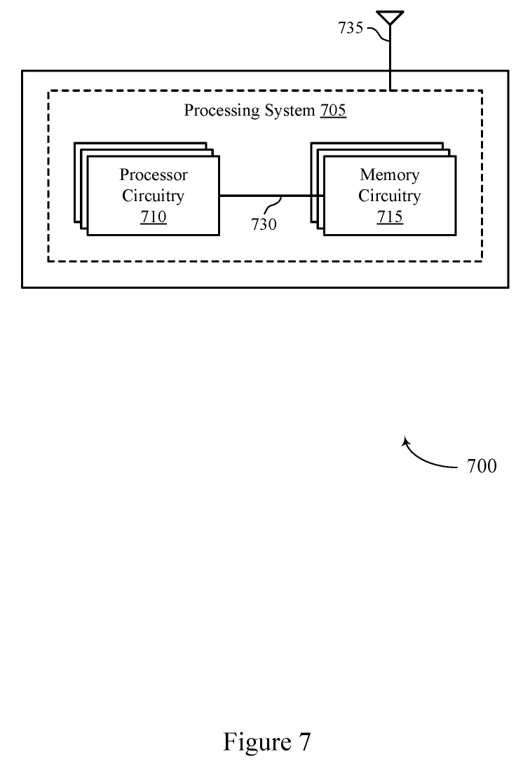

FIG. 7 shows a block diagram of an example wireless communication device 700 that supports automated driving plan notifications. A wireless communication device 700 may be capable of transmitting and receiving wireless communications in the form of, for example, wireless packets. For example, a wireless communication device 700 may be configurable or configured to transmit and receive signals and communications conforming to one or more 3GPP specifications including those for 5G NR or 6G, among others. In some examples, the techniques described herein may be performed or implemented in scenarios of direct communication between client devices (e.g., without involvement of a base station or an access point). Additionally, or alternatively, a wireless communication device 700 may be configurable or configured to transmit and receive signals and communications conforming to one or more of the IEEE 802.11 family of wireless communication protocol standards, among others. For example, the wireless communication device 700 may be configured to operate according to one or more direct communication protocol standards (e.g., which do not include an access point), such as IEEE802.11p or IEEE802.11db.

In some examples, a wireless communication device 700 may be a UE 115, a V2X device, an AV, a system at an AV, a non-AV road user, a system at (or otherwise associated with) a non-AV road user, or some other system. In some such examples, the wireless communication device 700 may be configured or configurable to perform one or more of the methods 500 or 600.

A wireless communication device 700 may include one or more chips, system on chips (SoCs), chipsets, packages, components or devices that individually or collectively constitute or include a processing system 705. A processing system 705 may interface with other components of a wireless communication device 700 and may generally process information (such as inputs or signals) received from such other components and output information (such as outputs or signals) to such other components. As shown in FIG. 7, the wireless communication device 700 includes a processing system 705 that includes processor circuitry 710 (such as one or more processor circuits or circuitry, processing circuitry, a processor) and memory circuitry 715 (such as one or more memory circuits or circuitry, a memory).

Processor circuitry 710 may be collectively configured to perform PHY layer operations and MAC layer operations, and, in some instances, upper layer operations, associated with transmitting and receiving wireless communications. Processor circuitry 710 may be implemented in the form of one or multiple processors, microprocessors, application processors, host processors, processing units (such as central processing units (CPUs), graphics processing units (GPUs), neural processing units (NPUs) (also referred to as neural network processors or deep learning processors (DLPs)), data processing units (DPUs), associative processing units (APUs), tensor processing units (TPUs), language processing units (LPU), vision processing units (VPUs), quantum processing units (QPUs) or digital signal processors (DSPs)), processing blocks, application-specific integrated circuits (ASIC), programmable logic devices (PLDs), or other discrete gate or transistor logic or circuitry (each of which may be generally referred to herein individually as “a processor” or “processor circuitry 710”). One or more processors of processor circuitry 710 may be individually or collectively configurable or configured to perform various functions or operations described herein. A group of processors of processor circuitry 710 collectively configurable or configured to perform a set of operations may include a first processor configurable or configured to perform a first operation of the set and a second processor configurable or configured to perform a second, different operation of the set. In some other examples, each of a group of processors of processor circuitry 710 may be configurable or configured to perform a same set of operations.

Memory circuitry 715 may be collectively configured for storing, accessing or retrieving stored information at the request of processor circuitry 710, including operations associated with transmitting and receiving wireless communications. Generally, components of memory circuitry 715 may be coupled with components of processor circuitry 710 and individually or collectively store processor-executable code that, when executed by the processor circuitry 710 (such as directly, indirectly, without pre-processing, after pre-processing), such as by one or more processors, may configure or enable the processor circuitry 710, such as one or more of the same or different processors, to perform various operations described herein. However, in some examples, some of the processor circuitry 710 may be preconfigured to perform various operations described herein without requiring configuration or enablement by code stored in the memory circuitry 715.

Memory circuitry 715 may be implemented in the form of one or more memory devices, memory components, memory blocks, memory elements or other discrete gate or transistor logic or circuitry. Memory circuitry 715 may include tangible storage media including non-volatile memory, such as read-only memory (ROM), or volatile memory, such as random-access memory (RAM) (such as static RAM (SRAM), dynamic RAM (DRAM), or synchronous DRAM (SDRAM) such as low power double data rate (LPDDR) memory, among other examples, each of which may be generally referred to herein individually as “a memory” or “memory circuitry 715”) In some examples, a processing system 705, and processor circuitry 710 within it, may also be coupled with memory circuitry outside of or distinct from the processing system 705. For example, such additional memory circuitry may include a non-volatile memory storage device such as a solid state drive (SSD), a hard disk drive (HDD), or removable storage media. In some other examples, additional memory circuitry also may include volatile memory such as SRAM, DRAM, SDRAM, LPDDR memory, among other examples.

Processor circuitry 710 may be coupled directly or indirectly with memory circuitry 715 via an interface 730 (such as one or more interfaces). An interface 730 may include any suitable quantities or types of interconnecting buses, bridges or circuitry depending on the specific applications and overall design constraints. In some examples, some or all of the processor circuitry 710 may be interconnected together within one chip, SoC, or package. Such a chip, SoC or package also may include memory circuitry 715 integrated within it. In some other examples, a processing system 705 may include any suitable combination of two or more distinct chips, SoCs, chipsets, packages, components or devices, each of which may include respective processor circuitry 710 or memory circuitry 715, or both.

A wireless communication device 700 may also include any additional circuitry or components for processor circuitry 710 to operate to perform the functions and processes described herein related to wireless communication. For example, as is also shown in FIG. 7, a processing system 705 may be directly or indirectly coupled with one or more antennas 735, which may be in the form of one or more individual antenna elements, antenna arrays, or antenna panels, among other examples. The one or more antennas 735 may include or be coupled with antenna circuitry, one or more antenna components, or one or more antenna modules, among other examples. Additionally, in some examples, a processing system 705, including processor circuitry 710, may include, be coupled with, or be connected to one or more modem circuits or circuitry (not specifically shown), such as in the form of one or more modem chips (also referred to herein simply as “modems”), each including processor circuitry configured for performing modulation or demodulation of wireless communication signals, among other functions associated with PHY layer operations. In some examples, a wireless communication device 700 may alternatively include distinct modem circuitry, such as one or more modems, separate from but coupled with or connected to a processing system 705, such as including processor circuitry 710.

In some examples, modem circuitry, whether implemented internal to or external to a processing system 705, may also include, be coupled with, or be connected to one or more RF and analog circuits or circuitry (not specifically shown). In some examples in which a processing system 705 includes modem circuitry, the processing system 705 may include at least some of the RF and analog circuitry. In some other examples, most or all of the RF and analog circuitry may be separate from but coupled directly or indirectly with or connected to a processing system 705, such as to the modem circuitry. The RF and analog circuitry may include RF chains or transceiver circuitry (such as transceivers), which may include one or more filters, mixers, oscillators, amplifiers such as power amplifiers (PAs) or low-noise amplifiers (LNAs), analog-to-digital converters (ADCs), digital-to-analog converters (DACs), power trackers, or other components that process signals including converting them between analog (such as for transmission or reception via an air interface) and digital (such as for processing by the processor circuitry 710) domains. The RF and analogy circuitry may, in turn, be coupled with or connected to antenna modules that connect to the physical antennas or antenna arrays.

In some examples, a wireless communication device 700 serving as a network entity 105, or a UE 115, may also include at least one other external network interface (not shown) that enables the processing system 705 to communicate with another network (such as a core network, a backhaul network) to gain access to external networks including the Internet. For example, a wireless communication device 700 configured as a network entity 105 may include multiple external network interfaces including one or more wired or wireless network interfaces (such as to support a backhaul link 132). A wireless communication device 700 configured as a UE 115 may also include one or more external network interfaces, such as a WLAN interface, to provide a backhaul.

Implementation examples are described in the following numbered clauses:

Aspect 1: A method, comprising: obtaining, by a system at an autonomous vehicle, first information indicative of one or more road users; and transmitting, via the transceiver, at least one instance of a notification message to at least one non-autonomous vehicle road user of the one or more road users, wherein the at least one instance of the notification message comprises second information applicable to coordinating a planned action for the autonomous vehicle with the at least one non-autonomous vehicle road user of the one or more road users.

Aspect 2: The method of aspect 1, wherein the second information comprises one or more longitudinal parameters, an estimated time of the planned action, a quantity of road users of the one or more road users yielded to by the autonomous vehicle, a respective location for each road user of the one or more road users, a respective type of road user of each road user of the one or more road users, a respective identifier for each road user of the one or more road users, or any combination thereof.

Aspect 3: The method of any of aspects 1 through 2, wherein obtaining the first information comprises: obtaining the first information via data from one or more sensors of the system, wherein the planned action, the second information, or both are based at least in part on the data from the one or more sensors.

Aspect 4: The method of any of aspects 1 through 3, wherein obtaining the first information comprises: receiving, via the transceiver, a second notification message from a road user of the one or more road users, wherein the second notification message includes third information applicable to coordinating a second planned action of the road user with the autonomous vehicle, and wherein the planned action of the autonomous vehicle, the second information, or both are based at least in part on the third information.

Aspect 5: The method of any of aspects 1 through 4, further comprising: generating, by the system, the notification message in accordance with the first information, wherein the notification message comprises the planned action for the autonomous vehicle; or generating, by the system and based at least in part on obtaining the first information, the planned action for the autonomous vehicle, wherein the planned action comprises a target velocity, a target acceleration, a target direction, a time of execution of the planned action, or any combination thereof, and wherein generating the notification message is based at least in part on the planned action.

Aspect 6: The method of any of aspects 1 through 5, wherein the first information indicates a respective type of road user for each road user of the one or more road users, a respective position for each road user of the one or more road users, a respective planned action for each road user of the one or more road users, or any combination thereof, and wherein generating the notification message comprises: generating, based at least in part on the first information, the notification message in accordance with a determination that the one or more road users are involved with the planned action.

Aspect 7: The method of any of aspects 1 through 6, further comprising: modifying, by the system, the planned action based at least in part on data from one or more sensors of the system, one or more notification messages from at least one road user of the one or more road users, or both; generating a second notification message in accordance with the modified planned action, wherein the second notification message comprises the modified planned action for the autonomous vehicle and third information applicable to coordinating the modified planned action with at least a second non-autonomous vehicle road user of the one or more road users; and transmitting, via the transceiver, at least one instance of the second notification message to at least the second non-autonomous vehicle road user of the one or more road users after generating the second notification message, wherein the at least one instance of the second notification message comprises respective third information for each road user of the one or more road users.

Aspect 8: The method of any of aspects 1 through 7, further comprising: transmitting, via the transceiver and in accordance with a periodicity, at least one second instance of the notification message to the at least one non-autonomous vehicle road user of the one or more road users after transmitting the at least one instance of the notification message.

Aspect 9: The method of any of aspects 1 through 8, further comprising: outputting, via a display of the system, an indication of the planned action based at least in part on transmitting the at least one instance of the notification message.

Aspect 10: A method, comprising: receiving, by a system associated with a non-autonomous vehicle road user via a transceiver, at least one instance of a notification message from an autonomous vehicle, wherein the notification message from the autonomous vehicle comprises: a planned action for the autonomous vehicle, and information applicable to coordinating the planned action with one or more road users including at least the non-autonomous vehicle road user.

Aspect 11: The method of aspect 10, wherein the information of the notification message comprises one or more first parameters applicable to the non-autonomous vehicle road user and one or more second parameters applicable to one or more second non-autonomous vehicle road users of the one or more road users.

Aspect 12: The method of any of aspects 10 through 11, wherein the information comprises one or more longitudinal parameters of the autonomous vehicle, an estimated time of the planned action of the autonomous vehicle, a quantity of road users yielded to by the autonomous vehicle, a respective location for each road user of one or more road users including the non-autonomous vehicle road user, a respective type of each road user the one or more road users, a respective identifier for each road user of the one or more road users, or any combination thereof.

Aspect 13: The method of any of aspects 10through 12, further comprising: receiving, by the system associated with the non-autonomous vehicle road user via the transceiver and from the autonomous vehicle, at least one instance of a second notification message after generating receiving the notification message, wherein the at least one instance of the second notification message comprises a modified planned action for the non-autonomous vehicle autonomous vehicle and third information applicable to coordinating the modified planned action with the road user.

Aspect 14: The method of any of aspects 10through 13, further comprising: receiving, by the system associated with the non-autonomous vehicle road user via the transceiver and in accordance with a periodicity, at least one second instance of the notification message from the autonomous vehicle after receiving the at least one instance of the notification message.

Aspect 15: The method of any of aspects 10 through 14, wherein the planned action comprises a target velocity of the autonomous vehicle, a target acceleration of the autonomous vehicle, a target direction of the autonomous vehicle, a time of execution of the planned action of the autonomous vehicle, or any combination thereof.

Aspect 16: The method of any of aspects 10 through 15, wherein the notification message supports a determination of whether the notification message is applicable to the non-autonomous vehicle road user based at least in part on the information.

Aspect 17: The method of any of aspects 10 through 16, wherein the notification message supports a determination of whether action is recommend for the non-autonomous vehicle road user based at least in part on the planned action, the information, or both.

Aspect 18: The method of any of aspects 10 through 17, wherein the notification message supports a determination of whether to output, by the system and based at least in part on the planned action, one or more first indications that action by the non-autonomous vehicle road user is recommended for collision avoidance, one or more second indications of a warning condition for the non-autonomous vehicle road user, or one or more third indications that the autonomous vehicle plans to yield to the non-autonomous vehicle road user.

Aspect 19: An apparatus comprising a transceiver and a processing system, where the processing system includes processor circuitry and memory circuitry that stores code, the processing system configured to perform a method of any of aspects 1 through 9.

Aspect 20: An apparatus comprising at least one means for performing a method of any of aspects 1 through 9.

Aspect 21: A non-transitory computer-readable medium storing code the code comprising instructions executable by one or more processors to perform a method of any of aspects 1 through 9.

Aspect 22: An apparatus comprising a processing system that includes processor circuitry and memory circuitry that stores code, the processing system configured to perform a method of any of aspects 10 through 18.

Aspect 23: An apparatus comprising at least one means for performing a method of any of aspects 10 through 18.

Aspect 24: A non-transitory computer-readable medium storing code the code comprising instructions executable by one or more processors to perform a method of any of aspects 10through 18.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of C-V2X (e.g., 4G, 5G, or 6G systems) may be described for purposes of example and corresponding terminology may be used in the description, the techniques described herein are applicable beyond such implementations. For example, the described techniques may be applicable to other communication systems such as Institute of Electrical and Electronics Engineers (IEEE) 802.11 (Wi-Fi) (e.g., without access point involvement), IEEE802.11p, IEEE802.11db, IEEE 802.20, Flash-OFDM, or other systems and radio technologies not explicitly mentioned herein.

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, investigating, looking up, inferring, ascertaining, measuring, resolving, selecting, obtaining, choosing, identifying, interpreting, demodulating, decoding, reading, establishing, forming, or generating, among other examples. In some examples, determining can involve a processing system performing some type of calculating, computing, deriving, estimating, inferring, ascertaining, resolving, predicting, or other processing to obtain one or more numerical values, sets, elements, or other information or results. In some examples, determining can involve a processing system identifying, looking up, investigating, or otherwise obtaining some type of value, set, element, or other information or result from a table, data structure, database, or an implementation of memory, such as from a larger set of values, sets, or elements or other information or results. In some examples, determining can involve a processing system identifying, interpreting, demodulating, decoding, detecting, reading, or otherwise obtaining some type of value, set, element, or other information or result signaled in, for example, a received wireless signal. In some examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b. Also, as used herein, the terms “has,” “have,” “having,” “comprise,” “comprising,” “include” and “including,” and derivatives thereof or similar terms are intended to be open-ended terms that do not limit an element that they modify (for example, an element “having” a also may have b).

As used herein, the phrase “based on” is equivalent to “based at least in part on” and indicates a non-limiting relationship between elements “a” and “b.” In some aspects, a’ (which may be a variation or example of a) may be responsive to or in response to b’ (which may be a variation or example of b), such as if condition c is met. In some other aspects, a’’ (which may be a variation or example of at least one of a or a’) may be associated with b’’ (which may be a variation or example of at least one of b or b’). In some further aspects, a’’’ (which may be a variation or example of at least one of a or a’ or a’’) may be determined (or any of the other actions encompassed by usage of the word “determining” as described above) in accordance with b’’’ (which may be a variation or example of at least one of b or b’ or b’’). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a transceiver; and
a processing system that includes processor circuitry and memory circuitry that stores code, the processing system configured to:
obtain, by a system at an autonomous vehicle, first information indicative of one or more road users; and
transmit, via the transceiver, at least one instance of a notification message to at least one non-autonomous vehicle road user of the one or more road users, wherein the at least one instance of the notification message comprises second information applicable to coordinating a planned action for the autonomous vehicle with the at least one non-autonomous vehicle road user of the one or more road users.

2. The apparatus of claim 1, wherein the second information comprises one or more longitudinal parameters, an estimated time of the planned action, a quantity of road users of the one or more road users yielded to by the autonomous vehicle, a respective location for each road user of the one or more road users, a respective type of road user of each road user of the one or more road users, a respective identifier for each road user of the one or more road users, or any combination thereof.

3. The apparatus of claim 1, wherein, to obtain the first information, the processing system is configured to:
obtain the first information via data from one or more sensors of the system, wherein the planned action, the second information, or both are based at least in part on the data from the one or more sensors.

4. The apparatus of claim 1, wherein, to obtain the first information, the processing system is configured to:
receive, via the transceiver, a second notification message from a road user of the one or more road users, wherein the second notification message includes third information applicable to coordinating a second planned action of the road user with the autonomous vehicle, and wherein the planned action of the autonomous vehicle, the second information, or both are based at least in part on the third information.

5. The apparatus of claim 1, wherein the processing system is further configured to:
generate, by the system, the notification message in accordance with the first information, wherein the notification message comprises the planned action for the autonomous vehicle; or
generate, by the system and based at least in part on obtaining the first information, the planned action for the autonomous vehicle, wherein the planned action comprises a target velocity, a target acceleration, a target direction, a time of execution of the planned action, or any combination thereof, and wherein the notification message is based at least in part on generating the planned action.

6. The apparatus of claim 1, wherein, to generate the notification message, the processing system is configured:
generate, based at least in part on the first information, the notification message in accordance with a determination that the one or more road users are involved with the planned action.

7. The apparatus of claim 1, wherein the processing system is further configured:
modify, by the system, the planned action based at least in part on data from one or more sensors of the system, one or more notification messages from at least one road user of the one or more road users, or both;
generate a second notification message in accordance with the modified planned action, wherein the second notification message comprises the modified planned action for the autonomous vehicle and third information applicable to coordinating the modified planned action with at least a second non-autonomous vehicle road user of the one or more road users; and
transmit, via the transceiver, at least one instance of the second notification message to at least the second non-autonomous vehicle road user of the one or more road users after generating the second notification message, wherein the at least one instance of the second notification message comprises respective third information for each road user of the one or more road users.

8. The apparatus of claim 1, wherein the processing system is further configured to:
transmit, via the transceiver and in accordance with a periodicity, at least one second instance of the notification message to the at least one non-autonomous vehicle road user of the one or more road users after transmitting the at least one instance of the notification message.

9. The apparatus of claim 1, wherein the processing system is further configured to:
output, via a display of the system, an indication of the planned action based at least in part on transmitting the at least one instance of the notification message.

10. An apparatus, comprising:
a transceiver; and
a processing system that includes processor circuitry and memory circuitry that stores code, the processing system configured to:
receive, by a system associated with a non-autonomous vehicle road user via the transceiver, at least one instance of a notification message from an autonomous vehicle,
wherein the notification message from the autonomous vehicle comprises:
a planned action for the autonomous vehicle, and
information applicable to coordinating the planned action with one or more road users including at least the non-autonomous vehicle road user.

11. The apparatus of claim 10, wherein the information of the notification message comprises:
one or more first parameters applicable to the non-autonomous vehicle road user, or
one or more second parameters applicable to one or more second non-autonomous vehicle road users of the one or more road users.

12. The apparatus of claim 10, wherein the information comprises one or more longitudinal parameters of the autonomous vehicle, an estimated time of the planned action of the autonomous vehicle, a quantity of road users yielded to by the autonomous vehicle, a respective location for each road user of one or more road users including the non-autonomous vehicle road user, a respective type of each road user the one or more road users, a respective identifier for each road user of the one or more road users, or any combination thereof.

13. The apparatus of claim 10, wherein the processing system is further configured to:
receive, by the system associated with the non-autonomous vehicle road user via the transceiver and from the autonomous vehicle, at least one instance of a second notification message after receiving the notification message, wherein the at least one instance of the second notification message comprises a modified planned action for the autonomous vehicle and third information applicable to coordinating the modified planned action with the non-autonomous vehicle road user.

14. The apparatus of claim 10, wherein the processing system is further configured to:
receive, by the system associated with the non-autonomous vehicle road user via the transceiver and in accordance with a periodicity, at least one second instance of the notification message from the autonomous vehicle after receiving the at least one instance of the notification message.

15. The apparatus of claim 10, wherein:
the planned action comprises a target velocity of the autonomous vehicle, a target acceleration of the autonomous vehicle, a target direction of the autonomous vehicle, a time of execution of the planned action of the autonomous vehicle, or any combination thereof.

16. The apparatus of claim 10, wherein the notification message supports a determination of whether the notification message is applicable to the non-autonomous vehicle road user based at least in part on the information.

17. The apparatus of claim 10, wherein the notification message supports a determination of whether action is recommend for the non-autonomous vehicle road user based at least in part on the planned action, the information, or both.

18. The apparatus of claim 10, wherein the notification message supports a determination of whether to output, by the system and based at least in part on the planned action, one or more first indications that action by the non-autonomous vehicle road user is recommended for collision avoidance, one or more second indications of a warning condition for the non-autonomous vehicle road user, or one or more third indications that the autonomous vehicle plans to yield to the non-autonomous vehicle road user.

19. A method, comprising:
obtaining, by a system at an autonomous vehicle, first information indicative of one or more road users; and
transmitting, by the system, at least one instance of a notification message to at least one non-autonomous vehicle road user of the one or more road users, wherein the at least one instance of the notification message comprises second information applicable to coordinating a planned action for the autonomous vehicle with the at least one non-autonomous vehicle road user.

20. The method of claim 19, wherein the second information comprises one or more longitudinal parameters, an estimated time of the planned action, a quantity of road users of the one or more road users yielded to by the autonomous vehicle, a respective location for each road user of the one or more road users, a respective type of road user of each road user of the one or more road users, a respective identifier for each road user of the one or more road users, or any combination thereof.
